(19) United States
(12) Patent Application Publication
(10) Pub. No.: US 2003/0132960 A1
(43) Pub. Date: Jul. 17, 2003

(54) Method and apparatus for modifying a message

(75) Inventor: Debora Margaret Hejzza Litwiller, Rochester, NY (US)

Correspondence Address: Patent Dcoumentatin Center, Xerox Corporation, 20th Floor Xerox Square, 100 Clinton Ave., Rochester, NY, 14644, US

(73) Assignee: Xerox Corporation

(21) Appl. No.: 10/042,961

(22) Filed: Jan. 11, 2002

(51) Int. Cl. G09G 5/00

(52) U.S. Cl. 345/752

(57) ABSTRACT

A message is modified in an apparatus prior to sending the message to a receiver. The message comprises a plurality of parameters, each parameter having a parameter value, each parameter value initially set to a default value, the plurality of message parameters thus initially having a corresponding plurality of parameter default values. It is determined when the user wants to modify at least one parameter. When it is determined that the user does not want to modify at least one parameter, the plurality of parameter default values is retained. When it is determined that the user wants to modify at least one parameter, the following process is followed for each parameter of the plurality of parameters: it is determined when the user wants to modify the parameter; when it is determined that the user does not want to modify the parameter, the corresponding parameter default value is retained; when it is determined that the user wants to modify the parameter, a plurality of choices for the user is displayed; it is determined when the user makes a selection based on the plurality of choices; when it is determined that the user has made a selection based on the plurality of choices, the parameter value is modified based on the user selection; when it is determined that the user has not made a selection, the corresponding parameter default value is retained. The message is then sent.

### FIELD OF THE INVENTION

This application relates to modifying a message prior to sending the message to a receiver.

### BACKGROUND OF THE INVENTION

Currently standalone communication devices are being developed to receive and transmit electronic documentation in the form of e-mails or internet transmitted faxes, also known as “internet fax”. With traditional data transmission protocols, there is an initial negotiating or “handshaking” session between the initiating (or “calling”) communication device and the target (or “called”) device. During this negotiation session, information about the communication parameters of the devices is exchanged. As a result of this “handshaking” exchange of communication parameters, the communication devices adjust their communication parameters in order to optimize and enhance the resulting information exchange.

However, during current e-mail or internet faxing transmissions, the foregoing “handshaking” exchange of communication parameters between the calling and called communication devices does not occur. As a result, if the calling device transmits information at one or more communication parameters that are not supported by the called device, the resulting information exchange will not be optimized, fail or be incomplete. Moreover, in a worst-case scenario, transmitted information may be lost.

The foregoing transmission problem is further complicated in cases where the calling communication device does not have “touch display screen” capability to visually present the information link to selection features.

As a result, there is a need for a method and apparatus for modifying a message prior to sending the message to a receiver.

### SUMMARY OF THE INVENTION

In one aspect of the invention, there is described a method for modifying a message in an apparatus prior to sending the message to a receiver, the message comprising a plurality of parameters, each parameter having a parameter value, each parameter value initially set to a default value, the method comprising determining when the user wants to modify at least one parameter and, when it is determined that the user wants to modify at least one parameter, for each parameter of the plurality of parameters, determining when the user wants to modify the parameter.

In another aspect of the invention, there is described an apparatus for modifying a message prior to sending the message to a receiver, the message comprising a plurality of parameters, each parameter having a parameter value, each parameter value initially set to a default value, the modifying based on a method comprising determining when the user wants to modify at least one parameter and, when it is determined that the user wants to modify at least one parameter, for each parameter of the plurality of parameters, determining when the user wants to modify the parameter.

In a further aspect of the invention, there is described a method for modifying a message in an apparatus prior to sending the message to a receiver, the message comprising a plurality of parameters, each parameter having a parameter value, each parameter value initially set to a default value, the plurality of message parameters thus initially having a corresponding plurality of parameter default values, the method comprising the steps of: determine when the user wants to modify at least one parameter; when it is determined that the user does not want to modify at least one parameter, retain the plurality of parameter default values; when it is determined that the user wants to modify at least one parameter, for each parameter of the plurality of parameters: determine when the user wants to modify the parameter; when it is determined that the user does not want to modify the parameter, retain the corresponding parameter default value; when it is determined that the user wants to modify the parameter, display a plurality of choices for the user; determine when the user makes a selection based on the plurality of choices; when it is determined that the user has made a selection based on the plurality of choices, modify the parameter value based on the user selection; and when it is determined that the user has not made a selection, retain the corresponding parameter default value.

### BRIEF DESCRIPTION OF THE DRAWINGS

FIG. 1 depicts an apparatus 1 for modifying a message 90 prior to sending the message 90 to a receiver 5 by means of a communication network 3. As shown, the message 90 comprises a plurality (N) of parameters 99 labeled P₁ through P_{N}, each parameter having a parameter value, each parameter value initially set to a default value, the plurality of message 90 parameters 99 thus initially having a corresponding plurality of parameter default values.

FIGS. 2-5 depict one embodiment of a flow diagram for a method or process for the apparatus 1 to modify the message 90, in accordance with the present invention.

### DESCRIPTION OF THE PREFERRED EMBODIMENT

Briefly, a message is modified in an apparatus prior to sending the message to a receiver. The message comprises a plurality of parameters, each parameter having a parameter value, each parameter value initially set to a default value, the plurality of message parameters thus initially having a corresponding plurality of parameter default values. It is determined when the user wants to modify at least one parameter. When it is determined that the user does not want to modify at least one parameter, the plurality of parameter default values is retained. When it is determined that the user wants to modify at least one parameter, the following process is followed for each parameter of the plurality of parameters: it is determined when the user wants to modify the parameter; when it is determined that the user does not want to modify the parameter, the corresponding parameter default value is retained; when it is determined that the user wants to modify the parameter, a plurality of choices for the user is displayed; it is determined when the user makes a selection based on the plurality of choices; when it is determined that the user has made a selection based on the plurality of choices, the parameter value is modified based on the user selection; and when it is determined that the user has not made a selection, the corresponding parameter default value is retained. The message is then sent. In one embodiment, the apparatus comprises an image forming device.

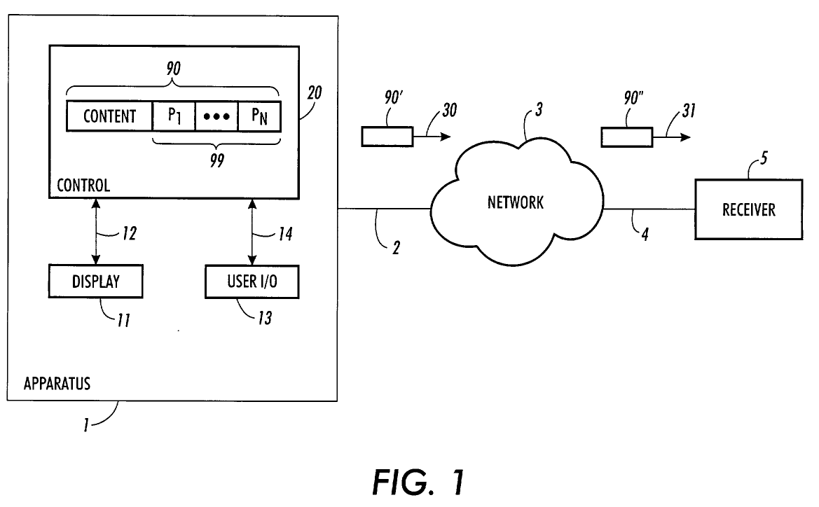

Referring now to FIG. 1, there is depicted an apparatus 1 for modifying a message 90 prior to sending the message 90 to a receiver 5. As shown, the message 90 comprises a plurality (N) of parameters 99 designated P₁ through P_{N}, each parameter having a parameter value, each parameter value initially set to a default value, the plurality of message 90 parameters 99 thus initially having a corresponding plurality of parameter default values.

Referring now to the apparatus 1, in one embodiment, the apparatus 1 sends the message 90 to the receiver 5 by means of a communication network 3. As shown, the apparatus 1 transmits 30 the dispatched or sent message 90′ to the communication network 3 by means of a first link 2. In turn, the communication network 3 transmits 31 the dispatched or sent message 90″ to the receiver 5 by means of a second link 4.

Referring now to the communication network 3, in one embodiment, the communication network 3 comprises an internet.

Referring now to the message 90, in one embodiment, the message 90 comprises an e-mail message.

In another embodiment, the message 90 comprises a facsimile message.

In a further embodiment, the message 90 comprises an internet facsimile message.

In yet another embodiment, the value of N equals 3, hence, the plurality of parameters comprises three (3) parameters.

In a still further embodiment, each parameter of the plurality of parameters 99 is based on the receiver 5.

In yet still another further embodiment, the plurality of parameters comprises a receiver resolution parameter, a compression parameter and a paper size parameter.

Referring now to the apparatus 1, in one embodiment, the apparatus 1 comprises an image forming device.

In another embodiment, the image forming device 1 comprises a facsimile machine.

In still another embodiment, the image forming device 1 comprises a printing machine.

Referring now to the remote receiver 5, in one embodiment, the remote receiver 5 comprises an image forming device.

In another embodiment, the remote image forming device 5 comprises a facsimile machine.

In still another embodiment, the remote image forming device 5 comprises a printing machine.

In one embodiment, the receiver 5 is remote from the apparatus 1.

Still referring to the apparatus 1, the message 90, including the plurality of parameters 99, are arranged to be controlled by a message control unit 20. In turn, the message control unit 20 is coupled 12 to a display unit 11 and is further coupled 14 to a user input/output (“I/O”) device 13. In one embodiment, the display unit 11 comprises a touch-sensitive or “touch screen” display unit. In another embodiment, the display unit 11 comprises an LCD display that is not touch-sensitive.

In one embodiment, the apparatus 1, by appropriate arrangement of the message control unit 20, the display unit 11 and the user I/O device 13, is arranged to display information to the user, such display various information including, but not limited, to the current values of the plurality of parameters 99.

In another embodiment, the apparatus 1, by appropriate arrangement of the message control unit 20, the display unit 11 and the user I/O device 13, is arranged for the user to access and control various information, including but not limited to, the current values of the plurality of parameters 99.

Moreover, in accordance with the present invention, the apparatus 1 is arranged for modifying the message 90 prior to sending the message 90 to the remote receiver 5, the message (90) comprising a plurality of parameters, each parameter having a parameter value, each parameter value initially set to a default value. In accordance with the present invention, the foregoing modifying is based on a method as hereinafter described.

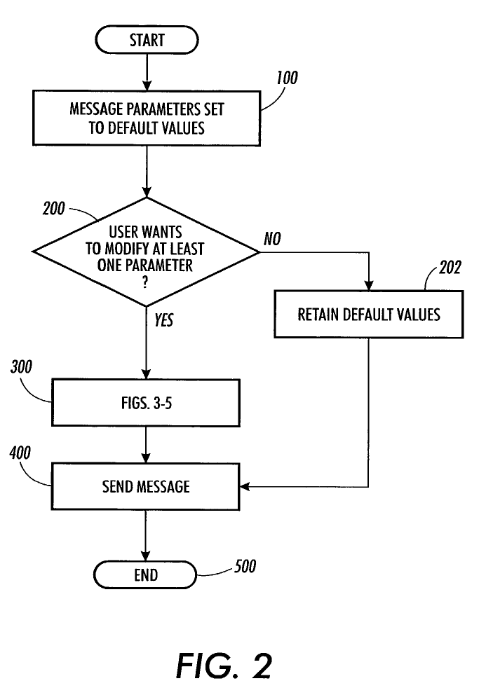

Referring now to FIGS. 2-5, there is depicted one embodiment of a flow diagram for a method or process for the apparatus 1 to modify the message 90, in accordance with the present invention.

Referring now to FIG. 2, the process starts in step 100, at a point wherein the message 90 comprises a plurality of parameters, each parameter value initially set to a default value, the plurality of message 90 parameters 99 thus initially having a corresponding plurality of parameter default values. The process goes to step 200.

In step 200, the process determines when the user of the apparatus 1 wants to modify at least one parameter of the plurality of parameters 99. When the result from this determination step 200 is negative, thus, when it is determined that the user does not want to modify at least one parameter of the plurality of parameters 99, then the process goes to step 202.

In step 202, the process retains the plurality of parameter default values in the corresponding plurality of parameters 99 in the message 90, as previously described in connection with step 100. The process then goes to step 400, which is described below.

Referring again to the step 200, otherwise, when the result from this determination step 200 is positive, thus, when it is determined that the user wants to modify at least one parameter of the plurality of parameters 99, then, as will be described in greater detail below, for each parameter of the plurality (N) of parameters 99, the following steps are performed: determine when the user wants to modify the parameter; when it is determined that the user does not want to modify the parameter, retain the corresponding parameter default value; when it is determined that the user wants to modify the parameter, display a plurality of choices for the user; determine when the user makes a selection based on the plurality of choices; when it is determined that the user has made a selection based on the plurality of choices, modify the parameter value based on the user selection; and when it is determined that the user has not made a selection, retain the corresponding parameter default value.

Next, the process goes to step 400.

In step 400, the process sends the message 90.

The process then ends, step 500.

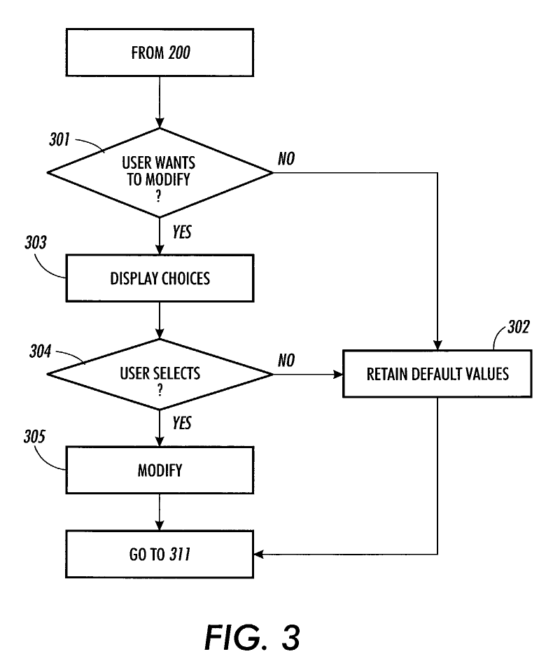

Referring now to FIGS. 2-5, in the particular embodiment of a flow diagram for a method for the apparatus 1 to modify the message 90 depicted therein, it is assumed that the value of N equals 3. Thus, the plurality of parameters comprises three (3) parameters, P₁, P₂ and P₃, wherein a first parameter, P₁, comprises a “receiver resolution” parameter, a second parameter, P₂, comprises a “compression” parameter and a third parameter, P₃, comprises a “paper size” parameter. Hence, when the result from this determination step 200 is positive, thus, when it is determined that the user wants to modify at least one parameter of the plurality of parameters 99, the process goes to step 301, which is shown in FIG. 3.

Referring now to FIG. 3, in step 301 the process determines when the user of the apparatus 1 wants to modify the first parameter, P₁, the resolution parameter. For example, in one embodiment, the display unit 11 questions the user “Do you know the receiver resolution?” or “Do you want to modify (or select) the receiver resolution?” In another embodiment, the display unit 11 determines the user's reply to the foregoing question based on the user touching either a first touch-sensitive portion of the display screen corresponding to “Yes” or a second touch-sensitive portion of the display screen corresponding to “No”. In a further embodiment, the user I/O unit 13 determines the user's reply based on the user activating corresponding input buttons or other input devices comprised in the user I/O unit 13.

When the result from this determination step 301 is negative, thus, when it is determined that the user of the apparatus 1 does not want to modify the resolution parameter, the process goes to step 302.

In step 302, the process retains the corresponding resolution parameter default value.

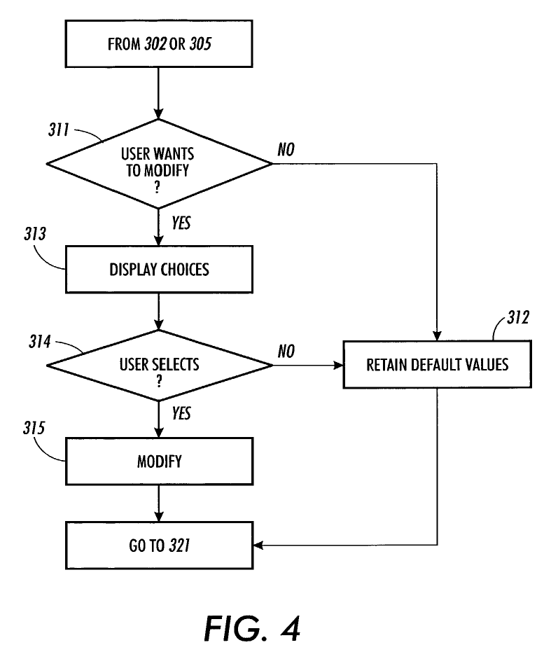

After step 302, the process goes to step 311, which is depicted in FIG. 4 and described below in connection therewith.

Referring again to step 301, when the result from this determination step 301 is positive, thus, when it is determined that the user of the apparatus 1 wants to modify the resolution parameter, the process goes to step 303.

In step 303, the process displays by means of the display unit 11 a plurality of resolution parameter choices, that is, a set of available resolution parameter values, for the user.

For example, in one embodiment, the display unit 11 displays the possible resolution parameter choices comprising 200 dots per inch (“dpi”), 400 dpi, 600 dpi and 800 dpi, and the user is invited to make her or his selection by touching the corresponding portion of the touch-sensitive display screen or by activating the corresponding input device or apparatus in the user l/O unit 13.

In another embodiment, the plurality of resolution parameter choices displayed in step 303 includes the choice “default”, that is, the resolution parameter default value.

Next, the process goes to step 304.

In step 304, the process determines when the user of the apparatus 1 makes a selection based on the plurality of choices for the resolution parameter which are displayed in step 303.

For example, in one embodiment, the display unit 11 determines the user's selection based on the user touching a touch-sensitive portion of the screen display corresponding to the user's selection for the resolution parameter. In another embodiment, the user I/O unit 13 determines the user's selection based on the user activating corresponding input buttons or other input devices comprised in the user I/O unit 13.

Referring still to step 304, it will be understood that occasionally this determination step 304 will have a negative result. For example, in one application, the determination step 304 result is negative when the process determines that the user selects the “default” choice. In another application, the determination step 304 result is negative when the process determines that the user fails to make a selection within a predetermined time period. Moreover, when the result from this determination step 304 is negative, thus, when it is determined that the user has not made a user selection, the process goes to step 302, which is described above.

When the result from this determination step 304 is positive, thus, when it is determined that the user of the apparatus 1 has made a user selection for the resolution parameter based on the plurality of choices displayed in step 303, the process goes to step 305.

In step 305, the process modifies the resolution parameter value based on the user selection determined in step 304. The process next goes to step 311, which is shown in FIG. 4 and described below in connection therewith.

Referring now to FIG. 4, in step 311 the process determines when the user of the apparatus 1 wants to modify the second parameter, P₂, the compression parameter. For example, in one embodiment, the display unit 11 questions the user “Do you know the receiver compression?” or “Do you want to modify (or select) the receiver compression?” In another embodiment, the display unit 11 determines the user's reply to the foregoing question based on the user touching either a first touch-sensitive portion of the display screen corresponding to “Yes” or a second touch-sensitive portion of the display screen corresponding to “No”. In a further embodiment, the process determines the user's reply based on the user activating the corresponding input device or apparatus in the user I/O unit 13. In a further embodiment, the user I/O unit 13 determines the user's reply based on the user activating corresponding input buttons or other input devices comprised in the user I/O unit 13.

When the result from this determination step 311 is negative, thus, when it is determined that the user of the apparatus 1 does not want to modify the compression parameter, the process goes to step 312.

In step 312, the process retains the corresponding compression parameter default value.

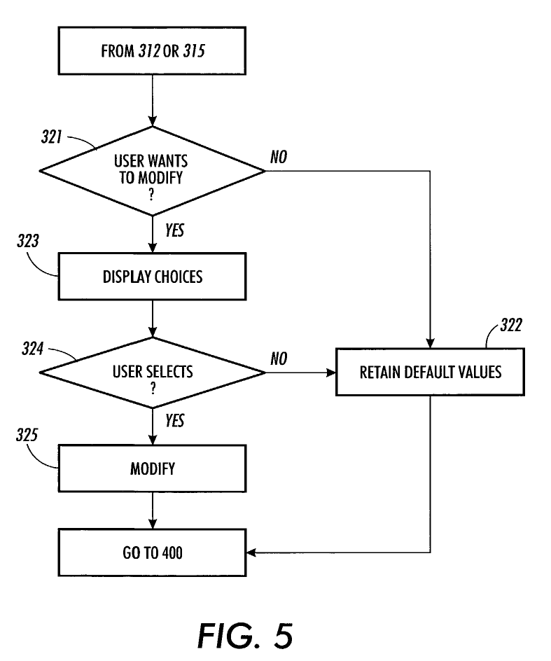

After step 312, the process goes to step 321, which is depicted in FIG. 5 and described below in connection therewith.

Referring again to step 311, when the result from this determination step 311 is positive, thus, when it is determined that the user of the apparatus 1 wants to modify the compression parameter, the process goes to step 313.

In step 313, the process displays by means of the display unit 11 a plurality of compression parameter choices, that is, a set of available compression parameter values, for the user.

For example, in one embodiment, the display unit 11 displays the possible compression parameter choices comprising MH, MR, MMR and JBIG, and the user is invited to make her or his selection by touching the corresponding portion of the touch-sensitive display screen or by activating corresponding input buttons or other input devices or apparatus comprised in the input I/O unit 13.

In another embodiment, the plurality of compression parameter choices displayed in step 313 includes the choice “default”, that is, the compression parameter default value.

Next, the process goes to step 314.

In step 314, the process determines when the user of the apparatus 1 makes a selection based on the plurality of choices for the compression parameter which are displayed in step 313.

For example, in one embodiment, the display unit 11 determines the user's selection based on the user touching a touch-sensitive portion of the screen display corresponding to the user's selection for the compression parameter. In another embodiment, the user I/O unit 13 determines the user's selection based on the user activating corresponding input buttons or other input devices comprised in the user I/O unit 13.

Referring still to step 314, it will be understood that occasionally this determination step 314 will have a negative result. For example, in one application, the determination step 314 result is negative when the process determines that the user selects the “default” choice. In another application, the determination step 314 result is negative when the process determines that the user fails to make a selection within a predetermined time period. Moreover, when the result from this determination step 314 is negative, thus, when it is determined that the user has not made a user selection, the process goes to step 312, which is described above.

When the result from this determination step 314 is positive, thus, when it is determined that the user of the apparatus 1 has made a user selection for the compression parameter based on the plurality of choices displayed in step 313, the process goes to step 315.

In step 315, the process modifies the compression parameter value based on the user selection determined in step 314. The process then goes to step 321, which is shown in FIG. 5 and described below in connection therewith.

Referring now to FIG. 5, in step 321 the process determines when the user of the apparatus 1 wants to modify the third parameter, P₃, the paper size parameter. For example, in one embodiment, the display unit 11 questions the user “Do you know the receiver paper size?” or “Do you want to modify (or select) the receiver paper size?” In another embodiment, the display unit 11 determines the user's reply to the foregoing question based on the user touching either a first touch-sensitive portion of the display screen corresponding to “Yes” or a second touch-sensitive portion of the display screen corresponding to “No”. In a further embodiment, the user I/O unit 13 determines the user's reply based on the user activating corresponding input buttons or other input devices comprised in the user I/O unit 13.

When the result from this determination step 321 is negative, thus, when it is determined that the user of the apparatus 1 does not want to modify the paper size parameter, the process goes to step 322.

In step 322, the process retains the corresponding paper size parameter default value.

After step 322, the process goes to step 400, which is depicted in FIG. 2 and described above in connection therewith.

Referring again to step 321, when the result from this determination step 321 is positive, thus, when it is determined that the user of the apparatus 1 wants to modify the paper size parameter, the process goes to step 323.

In step 323, the process displays by means of the display unit 11 a plurality of paper size parameter choices, that is, a set of available paper size parameter values, for the user.

For example, in one embodiment, the display unit 11 displays the possible paper size parameter choices comprising 8.5×11, 8.5×14, A4 and A3, and the user is invited to make her or his selection by touching the corresponding portion of the touch-sensitive display screen or by activating corresponding input buttons or other input devices or apparatus comprised in the input I/O unit 13.

In another embodiment, the plurality of paper size parameter choices displayed in step 323 includes the choice “default”, that is, the paper size parameter default value.

Next, the process goes to step 324.

In step 324, the process determines when the user of the apparatus 1 makes a selection based on the plurality of choices for the paper size parameter which are displayed in step 323.

For example, in one embodiment, the display unit 11 determines the user's selection based on the user touching a touch-sensitive portion of the screen display corresponding to the user's selection for the paper size parameter. In another embodiment, the user I/O unit 13 determines the user's selection based on the user activating corresponding input buttons or other input devices comprised in the user I/O unit 13.

Referring still to step 324, it will be understood that occasionally this determination step 324 will have a negative result. For example, in one application, the determination step 324 result is negative when the process determines that the user selects the “default” choice. In another application, the determination step 324 result is negative when the process determines that the user fails to make a selection within a predetermined time period. Moreover, when the result from this determination step 324 is negative, thus, when it is determined that the user has not made a user selection, the process goes to step 322, which is described above.

When the result from this determination step 324 is positive, thus, when it is determined that the user of the apparatus 1 has made a user selection for the paper size parameter based on the plurality of choices displayed in step 323, the process goes to step 325.

In step 325, the process modifies the paper size parameter value based on the user selection determined in step 324. The process then goes to step 400, which is shown in FIG. 2 and described above in connection therewith.

Thus, there is described a method for modifying a message 90 in an apparatus 1 prior to sending the message 90 to a receiver 5, the message 90 comprising a plurality of parameters 99, each parameter 99 having a parameter value, each parameter value initially set to a default value, the method comprising determining (reference number 200 in FIG. 2) when the user wants to modify at least one parameter and, when it is determined that the user wants to modify at least one parameter, for each parameter of the plurality of parameters 99, determining (reference number 301 in FIG. 3, reference number 311 in FIG. 4 and reference number 321 in FIG. 5) when the user wants to modify the parameter.

Also, there is described an apparatus 1 for modifying a message 90 prior to sending the message 90 to a receiver 5, the message 90 comprising a plurality of parameters 99, each parameter having a parameter value, each parameter value initially set to a default value, the modifying based on a method depicted in FIGS. 2-5 and described hereinabove in connection therewith comprising determining (reference number 200 in FIG. 2) when the user wants to modify at least one parameter and, when it is determined that the user wants to modify at least one parameter, for each parameter of the plurality of parameters, determining (reference number 301 in FIG. 3, reference number 311 in FIG. 4 and reference number 321 in FIG. 5) when the user wants to modify the parameter.

Further, there is described a method for modifying a message 90 in an apparatus 1 prior to sending the message 90 to a receiver 5, the message 90 comprising a plurality of parameters 99, each parameter having a parameter value, each parameter value initially set to a default value, the plurality of message parameters 99 thus initially having a corresponding plurality of parameter default values, the method comprising the steps of: determine (reference number 200 in FIG. 2) when the user wants to modify at least one parameter; when it is determined that the user does not want to modify at least one parameter, retain (reference number 202 in FIG. 2) the plurality of parameter default values; when it is determined that the user wants to modify at least one parameter, for each parameter of the plurality of parameters: determine (reference number 301 in FIG. 3, reference number 311 in FIG. 4 and reference number 321 in FIG. 5) when the user wants to modify the parameter; when it is determined that the user does not want to modify the parameter, retain (reference number 302 in FIG. 3, reference number 312 in FIG. 4 and reference number 322 in FIG. 5) the corresponding parameter default value; when it is determined that the user wants to modify the parameter, display (reference number 303 in FIG. 3, reference number 313 in FIG. 4 and reference number 323 in FIG. 5) a plurality of choices for the user; determine (reference number 304 in FIG. 3, reference number 314 in FIG. 4 and reference number 324 in FIG. 5) when the user makes a selection based on the plurality of choices; when it is determined that the user has made a selection based on the plurality of choices, modify (reference number 305 in FIG. 3, reference number 315 in FIG. 4 and reference number 325 in FIG. 5) the parameter value based on the user selection; and when it is determined that the user has not made a selection, retain the corresponding parameter default value.

In summary, the method and apparatus for modifying a message, in accordance with the present invention, comprises a process utilized by the calling communication device user interface to enable the calling device user to supply the needed information by the receiving communication device only if the user decides to send information using one or more communication parameters that may or may not be compatible with the called communication device. The user is only burdened with the flow if the calling device is taken off of default parameter values that would allow for guaranteed transmission, but at lower speed or quality. If the user selects to change the sending communication parameters, the unique link between the resolution button and the flow screens, walks the user through the needed information to insure the information will be processed by the called communication device. In one embodiment, if, at any time, the user cannot supply the correct parameter values, the calling communication device defaults to the guaranteed (“default”) communication parameter values.

While various embodiments of a method and apparatus for modifying a message, in accordance with the present invention, have been described hereinabove, the scope of the invention is defined by the following claims.

What is claimed is:

1. A method for modifying a message in an apparatus prior to sending the message to a receiver, the message comprising a plurality of parameters, each parameter having a parameter value, each parameter value initially set to a default value, the method comprising determining when the user wants to modify at least one parameter and, when it is determined that the user wants to modify at least one parameter, for each parameter of the plurality of parameters, determining when the user wants to modify the parameter.

2. The method of claim 1 comprising, when it is determined that the user wants to modify the parameter, displaying a plurality of choices to the user, determining a user selection based on the plurality of choices and modifying the parameter value based on the user selection.

3. The method of claim 2 comprising retaining the corresponding parameter default value when the user does not make a selection based on the plurality of choices.

4. The method of claim 1 comprising, when it is determined that the user does not want to modify the each parameter, retaining the corresponding parameter default value.

5. The method of claim 1, the displaying performed by means of an LCD display screen.

6. The method of claim 1, each parameter based on the receiver.

7. The method of claim 6, the plurality of parameters comprising a receiver resolution, a compression and a paper size.

8. The method of claim 1, the message comprising an e-mail message.

9. The method of claim 1, the message comprising a facsimile message.

10. The method of claim 1, comprising sending the message.

11. The method of claim 10, the sending comprising transmitting the message to the remote receiver by means of a communication network.

12. The method of claim 11, the communication network comprising an internet.

13. The method of claim 1, the apparatus comprising an image forming device.

14. The method of claim 13, the image forming device comprising a facsimile machine.

15. The method of claim 13, the image forming device comprising a printing machine.

16. Apparatus for modifying a message prior to sending the message to a receiver, the message comprising a plurality of parameters, each parameter having a parameter value, each parameter value initially set to a default value, the modifying based on a method comprising determining when the user wants to modify at least one parameter and, when it is determined that the user wants to modify at least one parameter, for each parameter of the plurality of parameters, determining when the user wants to modify the parameter.

17. The apparatus of claim 16, the method comprising, when it is determined that the user wants to modify the parameter, displaying a plurality of choices to the user, determining a user selection based on the plurality of choices and modifying the parameter value based on the user selection.

18. The apparatus of claim 17, the method comprising retaining the corresponding parameter default value when the user does not make a selection based on the plurality of choices.

19. The apparatus of claim 16, the method comprising, when it is determined that the user does not want to modify the parameter, retaining the corresponding parameter default value.

20. The apparatus of claim 16, the displaying performed by means of an LCD display screen.

21. The apparatus of claim 16, each parameter based on the receiver.

22. The apparatus of claim 21, the plurality of parameters comprising a receiver resolution, a compression and a paper size.

23. The apparatus of claim 16, the message comprising an e-mail message.

24. The apparatus of claim 16, the message comprising a facsimile message.

25. The apparatus of claim 16, the method comprising sending the message.

26. The apparatus of claim 25, the sending comprising transmitting the message to the remote receiver by means of a communication network.

27. The apparatus of claim 26, the communication network comprising an internet.

28. The apparatus of claim 16, the apparatus comprising an image forming device.

29. The apparatus of claim 28, the image forming device comprising a facsimile machine.

30. The apparatus of claim 28, the image forming device comprising a printing machine.

31. A method for modifying a message in an apparatus prior to sending the message to a receiver, the message comprising a plurality of parameters, each parameter having a parameter value, each parameter value initially set to a default value, the plurality of message parameters thus initially having a corresponding plurality of parameter default values, the method comprising the steps of: determine when the user wants to modify at least one parameter; when it is determined that the user does not want to modify at least one parameter, retain the plurality of parameter default values; when it is determined that the user wants to modify at least one parameter, for each parameter of the plurality of parameters: determine when the user wants to modify the parameter; when it is determined that the user does not want to modify the parameter, retain the corresponding parameter default value; when it is determined that the user wants to modify the parameter, display a plurality of choices for the user; determine when the user makes a selection based on the plurality of choices; when it is determined that the user has made a selection based on the plurality of choices, modify the parameter value based on the user selection; and when it is determined that the user has not made a selection, retain the corresponding parameter default value.

32. The method of claim 31 including a subsequent step of sending the message.

33. The method of claim 32, the sending comprising transmitting the message to the remote receiver by means of a communication network.

34. The method of claim 33, the communication network comprising an internet.

35. The method of claim 31, the displaying performed by means of an LCD display screen.

36. The method of claim 31, each parameter based on the receiver.

37. The method of claim 36, the plurality of parameters comprising a receiver resolution, a compression and a paper size.

38. The method of claim 31, the message comprising an e-mail message.

39. The method of claim 31, the message comprising a facsimile message.

40. The method of claim 31, the apparatus comprising an image forming device.

41. The method of claim 40, the image forming device comprising a facsimile machine.

42. The method of claim 40, the image forming device comprising a printing machine.

43. The method of claim 1, the user selection determining performed by means of a touch-sensitive display screen.

44. The apparatus of claim 16, the user selection determining performed by means of a touch-sensitive display screen.

45. The method of claim 31, the user selection determining performed by means of a touch-sensitive display screen.
